(19) United States
(12) Patent Application Publication
(10) Pub. No.: US 2007/0007832 A1
(43) Pub. Date: Jan. 11, 2007

(54) Jig, method, and device for assembling coil

(75) Inventors: Hirohisa Ichikawa, Anjo-shi (JP); Hiroshi Osada, Anjo-shi (JP); Tooru Kuroyanagi, Anjo-shi (JP); Hideaki Sugiura, Anjo-shi (JP); Tadayoshi Funahara, Anjo-shi (JP)

Correspondence Address: OLIFF & BERRIDGE, PLC, P.O. BOX 19928, ALEXANDRIA, VA, 22320, US

(73) Assignee: Aisin AW Co., Ltd., Anjo-shi, Aichi-ken (JP)

(21) Appl. No.: 10/558,414

(22) PCT Filed: Sep. 9, 2004
(86) PCT No.: PCT/JP04/13149

§ 371 Date: Nov. 28, 2005

(30) Foreign Application Priority Data
Sep. 10, 2003 (JP) 2003-318826

(51) Int. Cl. H02K 11/00; H02K 3/46

(52) U.S. Cl. 310/71; 310/260; 310/179

(57) ABSTRACT

A wound coil assembling jig is used to determine the length of a lead wire disposed at an end of a wound coil disposed on a stator core, and comprises a base plate and a holding device. The base plate has a mounting face mounted to an end of the stator core in an axial direction, a positioning device that positions the base plate with respect to the stator core in a circumferential direction, and an insertion opening which can receive a coil end portion, which is a portion of the wound coil protruding from the end of the stator core in the axial direction. The holding device is disposed at an outer face of the base plate, and holds the lead wire at the wound coil.

This application is the U.S. National State of PCT/JP2004/013149, filed Sep. 9, 2004, which claims priority from JP2003-4218826, filed Sep. 10, 2003, the entire disclosures of which are incorporated herein in their entireties.

### BACKGROUND

The disclosure relates to a wound coil assembling jig used when assembling a wound coil to a stator core, an assembly method, and an assembly device.

In a stator of a motor, a portion of a wound coil of electric wires is inserted into a slot in the inner circumferential surface of a stator core, and the remaining portion of wound coil protrudes from an end of the stator core in the axial direction thereof.

For example, in forming a three-phase motor, wound coils for three phases are disposed at a stator core. Crimping terminals are then connected by crimping to respective ends of lead wires disposed at respective ends of the wound coils to form power cables for supplying electric power, and the other ends of the lead wires disposed at the respective other ends of the wound coils are bundled to connect, by crimping, the crimping terminals to the entire bundled ends, so that a neutral point is formed in the three-phase motor. A method for forming a neutral point in the three-phase motor is disclosed in, for example, Japanese Unexamined Application Publication No. 2003-153505.

In order to mass-produce three-phase motors having the same form as that described above, the extension positions of the power cables and the position of the neutral point are determined in terms of design. A worker who assembles a three-phase motor determines the length of lead wires at wound coils for respective phases by disposing them along coil end portions, and, then cuts them in order to connect, by crimping, the crimping terminals to the lead wires.

However, after portions of the wound coils are inserted and disposed in the stator core, the shapes of the remaining portions of the wound coils protruding from the end of the stator core in the axial direction thereof, that is, the coil end portions, are not the same, and accordingly, it is difficult to determine the length of the lead wires placed along the coil end portions having different shapes. Consequently, the coil end portions are subjected to intermediate shaping and, then, the length of the lead wires is determined, after which the lead wires are cut. After forming the power cables and the neutral point, the neutral point is disposed along the coil end portions, and then, finishing shaping is carried out to shape the coil end portions again.

### SUMMARY

Accordingly, not only does it take time to form the power cables and the neutral point, but also, in some cases, the worker may make a mistake and erroneously determine the length of the lead wires.

The disclosure is made in light of such conventional problems. It is an object thereof to provide a wound coil assembling jig which enables reduction in the time required to determine the length of a lead wire and prevents differences in the length of the lead wires, and an assembling method thereof.

A first aspect is a wound coil assembling jig for determining the length of a lead wire disposed at an end of the wound coil assembled onto a stator core, the jig comprising a base plate having a mounting face mounted to an end of the stator core in an axial direction of the stator core, positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction; and holding means, disposed at an outer face of the base plate opposite to the mounting face, for holding the lead wire.

The wound coil assembling jig is a jig for determining the length of a lead wire disposed at the end of the wound coil assembled to the stator core. The assembling jig comprises the base plate having the mounting face, the positioning means, and the insertion opening, and the holding means.

In determining the length of a lead wire at the wound coil disposed at the stator core, the assembling jig is mounted to the stator core such that the mounting face of the base plate opposes the end of the stator core in the axial direction. Here, the assembling jig is mounted to the stator core such that the assembling jig is positioned with respect to the stator core in the circumferential direction by the positioning means disposed at the base plate. In addition, the end of the wound coil, disposed at the stator core, can be disposed in the insertion opening in the base plate.

In the state of the assembling jig being mounted to the stator core, the lead wire disposed at the end of the wound coil is extended to the holding means disposed at the base plate through the insertion opening. Here, the position of the holding means relative to the stator core in the circumferential direction is determined by the positioning means. The holding means can hold the lead wire, the length of which is determined to be a specified length. Subsequently, the lead wire whose length is determined to be a specified length is cut, and the crimping terminal is connected by crimping to the end of the lead wire.

Therefore, the use of the assembling jig makes it unnecessary to place the lead wire along the coil end portion when determining the length of the lead wire, so that it is not necessary to subject the coil end portion to intermediate shaping to determine the length of the lead wire. Consequently, it is possible to reduce the time required to determine the length of the lead wire.

In addition, because the length of the lead wire is determined by the assembling jig, the length of the lead wire is not erroneously determined, and variations in the length of the lead wire can be prevented.

The second aspect is a method for assembling a wound coil to a stator core, comprising disposing the wound coil, in which a portion of the wound coil is inserted into a slot formed in the inner circumferential surface of the stator core and the remaining portion of the wound coil is protruded from an end of the stator core in an axial direction of the stator core to form a coil end portion; determining a lead wire length, in which a mounting face of a assembling jig is mounted to the end of the stator core in the axial direction of the stator core and the assembling jig and the stator core are positioned in a circumferential direction of the stator core by positioning means, the lead wire disposed at an end of the wound coil is held by holding means, and the held lead wire is cut; using an assembling jig with a base plate having a mounting face mounted to an end of the stator core in an axial direction of the stator core, the positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction, and holding means, disposed at an outer face of the base plate opposite to the mounting face, for holding the lead wire; connecting a crimping terminal to the tip of the lead wire by crimping, with the lead wire held by the assembling jig; and shaping a coil end portion.

In the a wound coil assembling method, when assembling a wound coil to a stator coil, first, a portion of the wound coil is inserted into the slot of the stator core, and the remaining portion is made to protrude from an end of the stator core in the axial direction, so that a coil end portion is formed.

Then, the assembling jig is mounted to the end of the stator core in the axial direction. With the assembling jig and the stator core positioned in the circumferential direction, the holding means holds the lead wire disposed at the end of the wound coil. Then, the position of the assembling jig relative to the stator core in the circumferential direction is determined. Use of the assembling jig enables holding the lead wire, of which the length is determined, to a specified length. Therefore, it unnecessary to place the lead wire along the coil end portion when determining the length of the lead wire, so that it is unnecessary to subject the coil end portion to intermediate shaping to determine the length of the lead wire. Consequently, the time required to determine the length of the lead wire can be reduced, and the length of the lead wire can be kept from varying.

Next, in the state that the lead wire is held by the assembling jig, an end of the lead wire is connected by crimping to a crimping terminal. Therefore, the crimping terminal can be reliably connected by crimping to the end of the lead wire. In particular, when the wiring coil is a bundle of wound electric wires, the assembling jig holds together the electric wires forming the lead wire, so that all of the wires can be easily connected by crimping by the crimping terminal.

Thereafter, the coil end portion can be shaped to make the shape of the coil end portion uniform. Therefore, with regard to the shaping performed on the coil end, the shaping step only needs to be carried out once, for example, to complete the assembling of the wound coil to the stator core.

The third aspect is a wound coil assembling device comprising a wound coil assembling jig for determining the length of a lead wire disposed at an end of the wound coil assembled onto a stator core; lead wire processing means for performing working processing of the lead wire of which the length has been determined by the assembling jig; and relative movement means for relative movement between the lead wire processing means and the assembling jig, wherein the assembling jig comprises a base plate having a mounting face mounted to an end of the stator core in an axial direction of the stator core, positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction, and the coil assembly device further comprising holding means, disposed at an outer face of the base plate opposite to the mounting face, for holding the lead wire of the wound coil, wherein a plurality of the holding means are disposed on the base plate, and, following determining the length of the lead wire with the assembling jig, the lead wire processing means and the assembling jig are relatively moved by the relative movement means, whereby each lead wire held by each holding means is sequentially moved to the lead wire processing means, where the lead wire working processing is sequentially performed by the lead wire processing means.

The wound coil assembling device is a wound coil assembling device configured to efficiently perform the lead wire working processing using an assembling jig which exhibits the above-mentioned excellent operational advantages.

That is to say, the wound coil assembling device comprises the assembling jig, lead wire processing means, and relative movement means, and is configured such that the lead wires held by the holding means are sequentially moved to the lead wire processing means, where the lead wires are sequentially subjected to the working processing by the lead wire processing means. Accordingly, working processing of multiple lead wires can be easily performed while preventing the difference in the length formed in the assembling jig.

Consequently, with the wound coil assembling device, the amount of time necessary to determine the length of the lead wire can be shortened, differences in lengths of the lead wires can be prevented from occurring, and working processing of the lead wires can be easily performed.

### BRIEF DESCRIPTION OF THE DRAWINGS

The invention will be described with reference to the drawings, in which:

FIG. 1 is an explanatory diagram illustrating a state in which a assembling jig is mounted to a stator core having a wound coil disposed thereat, as viewed from an axial direction of the stator core, according to an exemplary embodiment;

FIG. 2 is a cross-sectional diagram showing the state in which a assembling jig is mounted to a stator core having a wound coil disposed thereat along arrows 2-2 in FIG. 1, according to the exemplary embodiment;

FIG. 3 is a cross-sectional diagram showing the state in which a assembling jig is mounted to a stator core having a wound coil disposed thereat taken along arrows 3-3 in FIG. 1, according to the embodiment;

FIG. 4 illustrates a stator having power cables and neutral points in the exemplary embodiment as viewed from the axial direction of the stator core;

FIG. 5 illustrates a state in which three-phase wound coils are mounted in slots in the stator core in the exemplary embodiment as viewed from the axial direction of the stator core;

FIG. 6 is a schematic illustration of a state in which the wound coils are mounted in the slots of the stator core;

FIG. 7 is a schematic illustration of an electrical circuit in which the neutral point is formed by a U-phase wound coil, a V-phase wound coil, and a W-phase wound coil connected in a star arrangement;

FIG. 8 illustrates the assembling jig in which two plate portion portions of a base plate are closed together;

FIG. 9 illustrates the assembling jig in which the two plate portions of the base plate are opened;

FIG. 10 is cross-sectional diagram illustrating a state in which lead wires are cut by a cutter while being held by the assembling jig;

FIG. 11 is cross-sectional diagram illustrating a state in which crimping terminals are connected by crimping to ends of the lead wires by a crimping device while the lead wires are held by the assembling jig;

FIG. 12 is cross-sectional diagram illustrating a state in which the crimping terminals are temporarily fixed at the ends of the lead wires by a temporary fixing device while the lead wires are held by the assembling jig;

FIG. 13 is a perspective schematic illustration of an assembly device according to a second exemplary embodiment; and

FIG. 14 illustrates the state of a stator core upon which wound coils are mounted being attached to the assembling jig, from the axial direction of the stator core.

### DETAILED DESCRIPTION

In the first through third aspects, the insertion opening can be formed as an insertion hole formed penetrating the base plate. Also, the insertion portion does not necessarily need to be formed of a circular hole, and for example may be formed as a region on the inner circumferential side of the base plate having a C-shaped form.

With the first aspect, the holding means preferably comprises an extension guide contacting the lead wire and defining an extension route for the lead wire, and a clamp holding the lead wire extending in the extension route. In this case, extending the lead wire of the wound coil disposed on the stator core following a predetermined extension route, and holding with the holding clamp, allows the lead wire to be determined to a specified length with even greater ease.

Also, preferably, the wound coil is a three-phase wound coil, and the lead wire for each phase is formed of a first lead wire formed at one end of the wound coil corresponding to the phase, and a second lead wire formed at the other end of the wound coil corresponding to the phase; with the holding means comprising first holding means separately holding each first lead wire, and second holding means bundling and holding the second lead wires.

In this case, three power cables for electric power supply can be formed in a short time with hardly any difference in lengths by determining the first lead wires to the specified length in the state that the first lead wires are each separately held by the first holding means. Also, the neutral point in the motor can be formed in a short time with hardly any difference in lengths by determining the lengths of the entirety of the bundled second lead wires to the specified length, in the state with the second holding means bundling and holding the second lead wires.

Also, the base plate is preferably dividable into multiple plate portions in the circumferential direction of the insertion opening. In this case, the base plate can be divided into multiple plate portions when attaching the base plate of the assembling jig to the stator core. The assembling jig can be easily attached to the stator core when attaching the base plate of the assembling jig to the stator core by combining the multiple plate portions so as to surround the coil end portion from directions orthogonal to the axial direction of the stator core, and attaching to the end portion of the stator core in the axial direction.

Also, the base plate preferably has two plate portions, with the ends of the two plate portions connected together at an end thereof, and the two plate portions being capable of being opened and closed with the connecting portion as a center.

In this case, the two plate portions of the base plate are opened with the connecting portion as a center when attaching the base plate of the assembling jig to the stator core. The coil end portion of the wound coil disposed on the stator core is passed between the other ends of the two plate portions, and then closed with the connecting portion as a center. Accordingly, the assembling jig can be easily assembled to the stator core, the same as above. Also, the two plate portions are connected by the connecting portions, so the two plate portions do not become separated, and storing of the assembling jig is facilitated.

Further, a plurality of the holding means are preferably disposed on the base plate, with the holding clamps configured so as to hold the lead wires extended outwards in the radial direction of the base plate. In this case, at the time of performing work processing of the lead wires held by the clamps, such as cutting or crimping or the like, the lead wire processing means for performing the work processing can be made to oppose the lead wire extended externally in the radial direction of the base plate. Accordingly, the work processing by the lead wire processing means on the lead wires held by the holding clamps can be facilitated.

Additionally, each holding clamp is preferably disposed on an imaginary circle. In this case, at the time of performing work processing of the lead wires held by the clamps, such as cutting or crimping or the like, the lead wire processing means for performing the work processing on the lead wire and the assembling jig can be relatively rotated, such that the holding clamps face the lead wire processing means. Accordingly, the work processing by the lead wire processing means on the lead wires held by the holding clamps can be facilitated.

Furthermore, each holding clamp is preferably disposed on one or a plurality of imaginary straight lines. In this case, at the time of performing work processing of the lead wires held by the holding clamps, such as cutting or crimping or the like, the lead wire processing means and the assembling jig can be relatively linearly moved, such that the holding clamps face the lead wire processing means. Accordingly, the work processing by the lead wire processing means on the lead wires held by the holding clamps can be facilitated.

With the second aspect, preferably, the wound coil is a three-phase wound coil, and the lead wire for each phase is formed of a first lead wire formed at one end of the wound coil corresponding to the phase, and a second lead wire formed at the other end of the wound coil corresponding to the phase; wherein, in the lead wire length determining step, each first lead wire is separately held and cut, and the second lead wires are held and cut in a bundled state; and, in the crimping terminal connecting step, a first crimping terminal is connected by crimping to the ends of the first lead wires, so that a power cable for power supply is formed, and a second crimping terminal is connected by crimping to an end of the entirety of the second lead wires held in the bundled state, so that a neutral point is formed.

In this case, a power cable for electric power supply can be formed in a short time without hardly any difference in lengths, by determining the first lead wires to the specified length in the state that the first lead wires are each separately held by the first holding means. Also, the neutral point in the motor can be formed in a short time with hardly any difference in lengths by determining the specified length of the entirety of the bundled second lead wires to the specified length, in the state with the second holding means bundling and holding the second lead wires.

Also, preferably, a plurality of the holding means are disposed on the base plate, the holding means comprising an extension guide contacting the lead wire and defining an extension route for the lead wire, and a clamp holding the lead wire extending in the extension route, wherein, in the lead wire length determining step, the holding clamps hold the lead wires in a state extended outwards in the radial direction of the base plate, and the held lead wires are cut. In this case, the lead wires of the wound coils disposed on the stator core are extended following the predetermined extension route, and held by the holding clamps, whereby the lead wires can be determined to the specified length even more easily. Also, in this case, the lead wires held by the holding clamps can be easily cut at the external radial position of the base plate.

Further, each holding clamp is preferably disposed on an imaginary circle. In this case, in the lead wire length determining step, the assembling jig is rotated relative to the cutting device so that the holding clamps sequentially face the cutting device, whereby the lead wires held by the holding clamps can be sequentially cut by the cutting device. Accordingly, cutting of the lead wires can be easily performed.

Also, in this case, in the crimping terminal connecting step, the assembling jig is rotated relative to the crimping device so that the holding clamps sequentially face the crimping device, whereby crimping terminals can be sequentially connected by crimping to the tips of the lead wires held by the holding clamps, by the crimping device. Accordingly, connection by crimping of crimping terminals to the tips of the lead wires can be easily performed.

Also, each holding clamp is preferably disposed on one or a plurality of imaginary straight lines. In this case, in the lead wire length determining step, The assembling jig is linearly moved relative to the cutting device so that the holding clamps sequentially face the cutting device, whereby the lead wires held by the holding clamps can be sequentially cut by the cutting device. Accordingly, cutting of the lead wires can be easily performed.

Additionally, in this case, in the crimping terminal connecting step, the assembling jig is linearly moved relative to the crimping device so that the holding clamps sequentially face the crimping device, whereby crimping terminals can be sequentially connected by crimping to the tips of the lead wires held by the holding clamps by the crimping device. Accordingly, connection by crimping of crimping terminals to the tips of the lead wires can be easily performed.

Also, the lead wire length determining step is preferably carried out while the stator core is loaded on a rotating device, with the crimping terminal connecting step being carried out after moving the lead wire or lead wires to an arbitrary location in the circumferential direction of the wound coil by rotating the rotating device following the lead wire length determining step. In this case, the position in the circumferential direction of the lead wires regarding which the length has been determined and which are held by the holding means can be easily changed, and the crimping terminal connecting step is facilitated.

Further, the crimping terminal connecting step is preferably carried out after moving the lead wire or lead wires to an arbitrary location in the circumferential direction of the stator core by loading the stator core on which the wound coils are mounted onto the rotating device, and rotating the rotating device following the lead wire length determining step. In this case as well, the position in the circumferential direction of the lead wires regarding which the length has been determined and which are held by the holding means can be easily changed, and the crimping terminal connecting step is facilitated.

With the third aspect, preferably, the holding means comprise an extension guide contacting the lead wire and defining an extension route for extending the lead wire, and a clamp holding the lead wire extending in the extension route, wherein the holding clamps hold the lead wires in a state extended outwards in the radial direction of the base plate. In this case, the lead wires of the wound coils disposed on the stator core are extended following the predetermined extension route, and held by the holding clamps, whereby the lead wires can be determined to the specified length even more easily. Also, in this case, the lead wires held by the holding clamps can be easily cut at the external radial position of the base plate.

Also, preferably, each holding clamp is disposed on an imaginary circle, with the relative movement means being a rotating device for relatively rotating the lead wire processing means and the assembling jig. In this case, at the time of performing work processing of the lead wires held by the holding clamps, the lead wire processing means and the assembling jig can be relatively rotated by the rotating device, such that the holding clamps face the lead wire processing means. Accordingly, the work processing by the lead wire processing means on the lead wires held by the holding clamps can be facilitated.

Also, preferably, each holding clamp is disposed on one or a plurality of imaginary straight lines, with the relative movement means being a sliding device for relatively linearly moving the lead wire processing means and the assembling jig. In this case, at the time of performing work processing of the lead wires held by the holding clamps, the lead wire processing means and the assembling jig can be relatively linearly moved by the sliding device, such that the holding clamps face the lead wire processing means. Accordingly, the work processing by the lead wire processing means on the lead wires held by the holding clamps can be facilitated.

Further, the work processing performed by the lead wire processing means is preferably at least one of cutting processing of the lead wire regarding which the length has been determined by the assembling jig, and crimping processing for performing connection by crimping of crimping terminals to the tips of lead wires following the cutting processing. In this case, at least one of cutting processing and crimping processing of multiple lead wires can be easily performed while preventing the difference from occurring in the lengths formed in the assembling jig.

Note that, as the work processing, prior to performing the crimping processing, temporary fixing processing for temporarily fixing the crimping terminals to the tips of the lead wires following the cutting processing, may be performed.

Hereunder, a description of exemplary embodiments of a wound coil assembling jig, an assembling method, and an assembling device will be given with reference to the drawings.

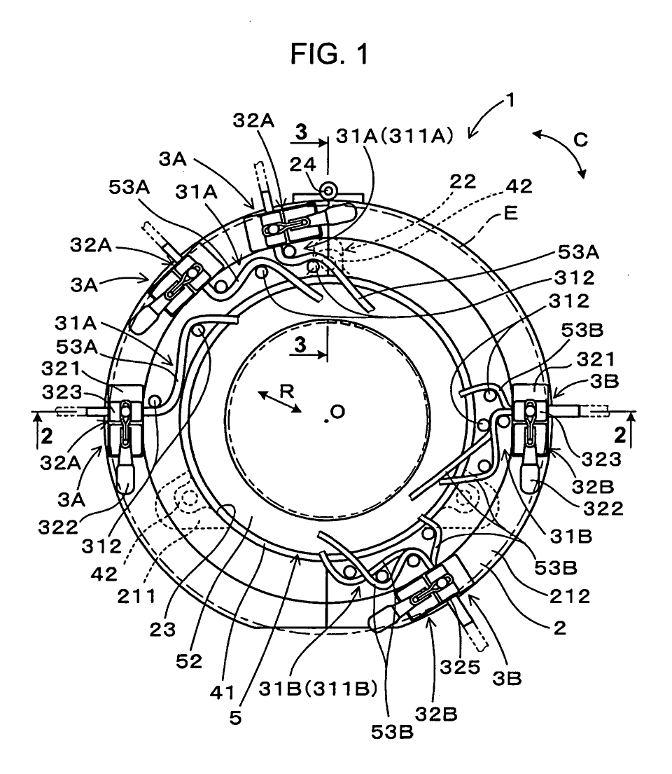

As shown in FIGS. 1 through 3, a wound coil assembling jig 1 according to the first exemplary embodiment is used to determine the lengths of lead wires 53 disposed at ends of wound coils 5 disposed at a stator core 41 for a motor. The assembling jig 1 comprises a base plate 2 and holding means 3A, 3B described below.

That is, the base plate 2 is a plate serving as a base of the assembling jig 1, and has a mounting face 211 mounted to an end 410 of the stator core 41 in an axial direction (end portion in the axial direction L), positioning means 22 disposed at the mounting face 211 for positioning the base plate 2 with respect to the stator core 41 in a circumferential direction C, and an insertion opening 23, which can receive insertion of coil end portions 52, which are portions of the wound coils 5 protruding from the ends 410 of the stator core 41 in the axial direction. The holding means 3A, 3B are disposed at an outer face 212 opposite to the mounting face 211 of the base plate 2 (which includes plastic side layers 202 and intermediate metal layer 201), and can hold the lead wires 53 at the wound coils 5.

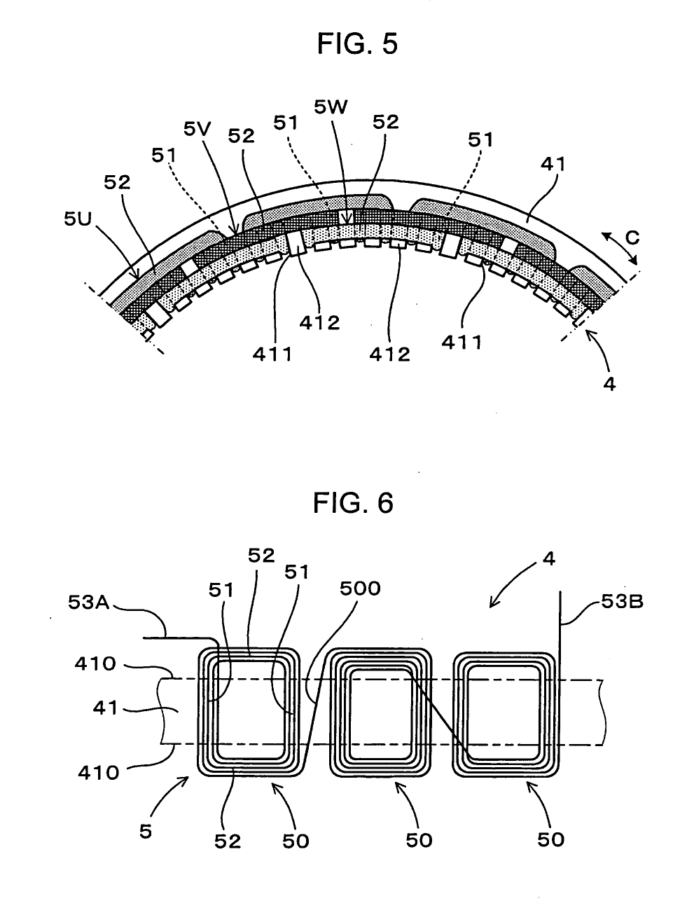

First, a stator 4, comprising the wound coils 5 assembled to the stator core 41 will be described in detail. As shown in FIGS. 4-7, with the present embodiment, the stator 4 is formed in a three-phase motor (three-phase AC motor). As shown in FIG. 5, the stator 4, of the three-phase motor, comprises the wound coils 5 for the three phases of U phase, V phase, and W phase, inserted and disposed in slots 411 in the inner circumferential surface of the stator core 41. Also, as shown in FIG. 6, the wound coils 5 for each phase are formed of multiple unipolar coils 50 which are each multiple winds of electrical wire 500, connected together. Each unipolar coil 50 comprises a pair of insertion sides 51 inserted and disposed in the slots 411 and a pair of coil end portions 52 connected to the corresponding pair of insertion sides 51. The electric wires 500 in the embodiment are a plurality of bundled wires.

As shown in FIG. 5, in the stator 4, the pair of insertion sides 51 of the wound coil 5U of the U phase is inserted and disposed in the slots 411, and the pair of coil end portions 52 of the wound coil 5U protrudes from the ends 410 of the stator core 41 in the axial direction. Also, the pair of insertion sides 51 of the wound coil 5V of the V phase is inserted and disposed in the slots 411 by offsetting the insertion sides 51 with respect to the wound coil 5U in one circumferential direction (circumferential direction) C of the stator core 41 by a predetermined number of slots, and portions of the pair of coil end portions 52 of the wound coil 5U overlap on the inner circumferential sides of the pair of coil end portions 52 of the wound coil 5U of the U phase.

As also shown in FIG. 5, the pair of insertion sides 51 of the wound coil 5W of the W phase is inserted and disposed in the slots 411 by offsetting the insertion sides 51 with respect to the wound coil 5V of the V phase in one circumferential direction C of the stator core 41 by a predetermined number of slots, and portions of the pair of coil end portions 52 of the wound coil 5V overlap on the inner circumferential sides of the pair of coil end portions 52 of the wound coil 5V of the V phase.

The stator 4 in the present embodiment is a distributed winding type in which the wound coils 5 of the electric wires 500 are inserted and disposed by being distributed in the plurality of slots 411 in the stator core 41. However, the stator 4 may be a concentrated winding type in which the wound coils 5 of the electric wires 500 are wound at teeth 412 between each slot 411 of the stator core 41.

As shown in FIG. 5, the wound coils 5 in the present embodiment are three-phase wound coils 5 for forming the stator 4 in the three-phase motor as described above, and in the wound coils 5 for the U phase, the V phase, and the W phase, the lead wires 53 comprise first lead wires 53A disposed at one end of the wound coils 5 and second lead wires 53B disposed at the other end of the wound coils 5.

As shown in FIGS. 4 and 7, in the stator 4, power cables 71 for the U phase, the V phase, and the W phase for supplying electric power to the three-phase motor are formed using the first lead wires 53A of the wound coils 5 of the three phases. The power cables 71 of the respective phases comprise first crimping terminals 6A having mounting ends 61 and being connected by crimping to ends of the respective first lead wires 53A.

Also, in the stator 4, the second lead wires 53B at the wound coils 5 of the three phases are bundled in order to form neutral points 72 in the three-phase motor by fusing the entire ends of the bundled second lead wires 53B of the respective phases by second crimping terminals 6B. FIG. 7 is an explanatory diagram showing an electrical circuit formed of the wound coils 5 for each of the phases. The stator 4 in the embodiment has the neutral points 72 formed by connecting the wound coils 5 for each of the phases in a star arrangement.

Also, in the stator 4 in the embodiment, two sets of the wound coils 5 for the three phases (hereinafter also referred to as “three-phase wound coils 5”) are provided, and are inserted and disposed in the stator core 41. The two sets of the three-phase wound coils 5 are connected in a star arrangement in parallel to form two neutral points 72 (see FIG. 4).

In the stator 4, the first lead wires 53A at the wound coils 5U of each set are bundled in order to form the power cable 71 of the U phase, the first lead wires 53A at the wound coils 5V of each set are bundled in order to form the power cable 71 of the V phase, and the first lead wires 53A at the wound coils 5W of each set are bundled in order to form the power cable 71 of the W phase. The two neutral points 72 are formed corresponding to the two sets of wound coils 5 for the three phases by bundling the second lead wires 53B at the wound coils 5 of the U phase, the V phase, and the W phase of the two sets.

The assembling jig 1 will now be described in detail. As shown in FIGS. 1, 8 and 9, the base plate 2 of the assembling jig 1 has a ring shape having the insertion opening 23, and can be divided into two plate portions 20 in the circumferential direction C of the insertion opening 23. One end 205 of the two plate portions 20 is connected at a connecting portion 24, and the two plate portions 20 can be opened and closed with the connecting portion 24 as a center.

A rotating member 241, for enabling opening and closing of the two plate portions 20, is disposed at the connecting portion 24. The two plate portions 20 of the base plate 2 can be opened and closed by rotating the two plate portions 20 on the rotating member 241, and are not detached from each other.

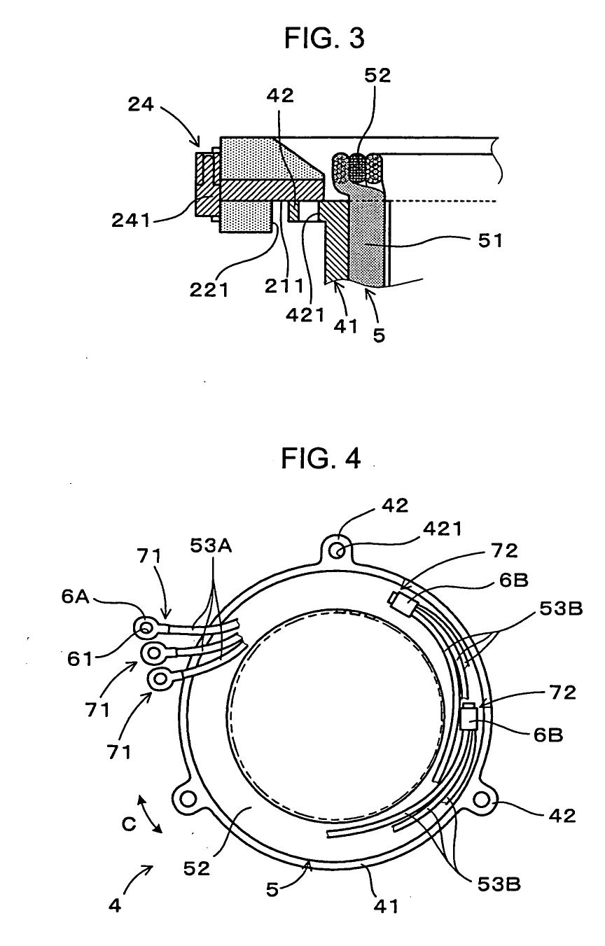

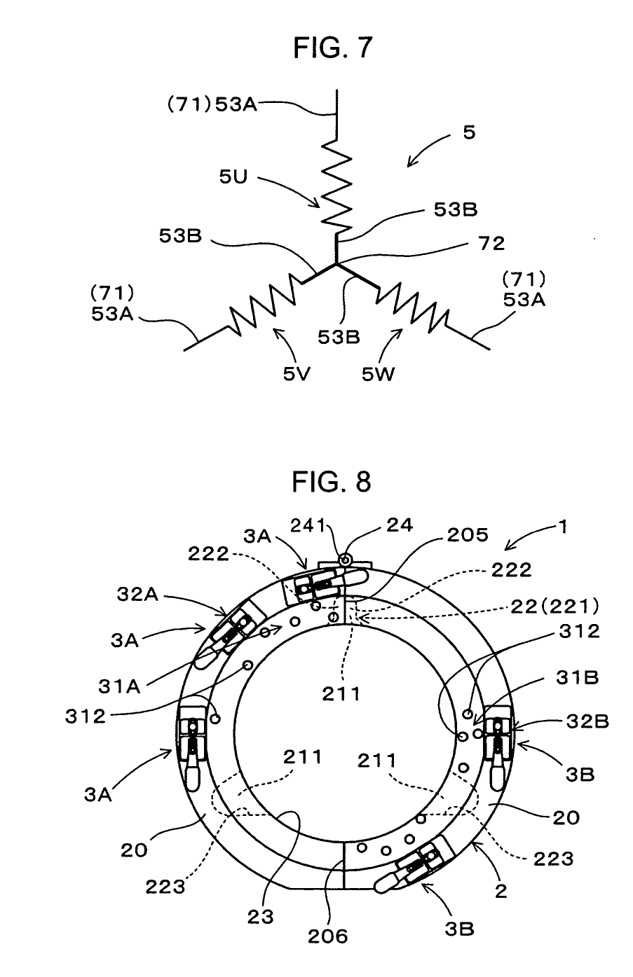

As shown in FIG. 4, the stator core 41 has mounting portions 42, which protrude outward in radial directions, disposed at the outer circumferential surface near the end 410 in the axial direction, and the mounting portions 42 have attaching holes 421 for receiving fasteners, such as bolts. As shown in FIGS. 3 and 8, the positioning means 22 of the base plate 2 is formed as an engaging portion 221 for engaging with the mounting portions 42 of the stator core 41. The engaging portion 221 comprises a pair of positioning cutaway portions 222 that are recessed from the mounting face 211 at the ends 205 of the two plate portions 20. The mounting face 211 of the base plate 2 in the embodiment is disposed at a location opposing the mounting portions 42.

As shown in FIG. 1, when the two plate portions 20 are brought together with the connecting portion 24 as a center, the assembling jig 1 can be positioned with respect to the stator core 41 in the circumferential direction C by clamping a mounting portion 42 of the stator core 41 between the positioning cutaway portions 222.

As shown in FIG. 4, the mounting portions 42 are disposed at three locations of the stator core 41, and one of the three mounting portions 42 is used for the positioning. In addition, as shown in FIG. 8, cutaway portions 223, where positioning is not carried out with respect to the two remaining mounting portions 42 in the circumferential direction C, are formed in the locations of the base plate 2 opposing the remaining two mounting portions 42.

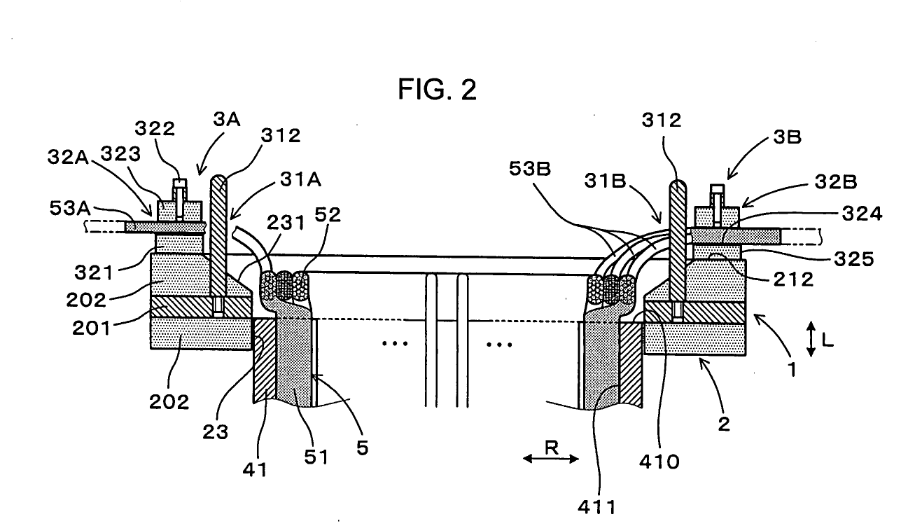

As shown in FIG. 2, the insertion opening 23 of the base plate 2 has an annular tapered face 231 formed at an inside wall end disposed adjacent the outer face 212 and inclined with increasing diameter towards the outer face 212 from the mounting face 211. The annular tapered face 231 make it easier to extend the lead wires 53 of the wound coils 5 towards the holding means 3.

In order to increase the strength of the base plate 2, plastic side layers 202 are secured to both surfaces of an intermediate metal layer 201. Multiple guide pins 312 of the extension guides 31 are secured to the intermediate layer 201.

As shown in FIG. 1, the holding means 3 of the assembling jig 1 comprises first holding means 3A for separately holding the first lead wires 53A of the respective phases and second holding means 3B for holding the bundled second lead wires 53B.

The first holding means 3A comprises a first extension guide 31A contacting its corresponding first lead wire 53A to define a corresponding first route 311A for extending its corresponding first lead wire 53A, and a first clamp 32A which holds the corresponding first lead wire 53A extending along the first route 311A.

Also, the second holding means 3B comprises a second extension guide 31B contacting the second lead wires 53B and define second routes 311B for extending the second lead wires 53B, and a second clamp 32B which bundles and holds the second lead wires 53B extending along their second extension routes 311B.

In the present embodiment, in order to form three power cables 71, three first holding means 3A are formed, and, in order to form two neutral points 72, two second holding means 3B are formed.

Also, as shown in FIGS. 1 and 2, the first extension guides 31A and the second extension guides 31B in the embodiment each comprise the multiple guide pins 312 on the base plate 2.

More specifically, each first extension guide 31A comprises two guide pins 312, and the space between the two guide pins 312 defines the first extension route 311A. By extending the first lead wires 53A of the respective wound coils 5 to the first holding clamps 32A through the first routes 311A, each defined by the two guide pins 312, the length of the first lead wires 53A can be set to a specified length.

Each second extension guide 31B comprises four guide pins 312, with the second extension routes 311B being defined between the four guide pins 312 or extending near the guide pins 312. By extending each second lead wire 53B for each phase to its second clamp 32B through its second extension route 311B defined by the four guide pins 312, the length of the bundled second lead wires 53B for the three phases can be set to a specified length.

As shown in FIGS. 1 and 2, each first clamp 32A and each second clamp 32B comprises a fixing member 321 secured to the outer face 212 of the base plate 2 and a toggle clamp portion 322 disposed at the corresponding fixing member 321. Clamping members 323 for clamping the first lead wires 53A or the second lead wires 53B between the toggle clamp portions 322 and the secured members 321 are secured to ends of the toggle clamp portions 322.

Also, the holding clamps 32A, 32B are configured so as to hold the lead wires 53A, 53B extended externally in the radial direction R of the base plate 2.

That is to say, a placement groove 324, for placing the first lead wire 53 and the second lead wire 53B, is formed in the radial direction R on the fixing member 321 of the first holding clamp 32A and the second holding clamp 32B. The lead wires 53A, 53B are externally extended from the inner side of the radial direction R through the placement grooves 324, and clamping by the clamping members 323 realizes holding thereof by the holding clamps 32A, 32B

Also, the holding clamps 32A, 32B are disposed at positions having approximately the same radius from the center O of the base plate 2, i.e., from a center axial line of the stator core 41 attached to the base plate 2. That is to say, the holding clamps 32A, 32B are disposed on the base plate 2 such that the edge portions (outer edge portions in the radial direction) 325 of the fixing members 321 thereof, positioned outwards in the radial direction R, are aligned on an imaginary circle E of which the center O matches the center axial line of the stator core 41 attached to the base plate 2.

Next, a description of the method for assembling the wound coils 5 for the three phases to the stator core 41 will be given. In the present embodiment, the wound coils 5 of the three phases are assembled to the stator core 41 so that the stator 4 of the three-phase motor is formed, by a winding step, a lead wire length determining step, a crimping terminal connecting step, and a coil end portion shaping step.

In the winding step, portions of the wound coils 5 for each phase are inserted into the slots 411 in the inner circumferential surface of the stator core 4, and the remaining portions of the wound coils 5 for each phase are made to protrude from the ends 410 of the stator core 41 in the axial direction, so that the coil end portions 52 are formed.

Next, in the lead wire length determining step, the lengths of the first lead wires 53A and the second lead wires 53B of the wound coils 5, disposed at the stator core 41, are determined, and the first lead wires 53A and the second lead wires 53B are cut to the specified lengths.

That is, in determining the lengths of the first lead wires 53A and the second lead wires 53B of the three-phase wound coils 5 disposed at the stator core 41, first, the assembling jig 1 is mounted to the stator core 41 while the mounting face 211 of the base plate 2 opposes the end 410 of the stator core 41 of the mounting portion 42 in the axial direction.

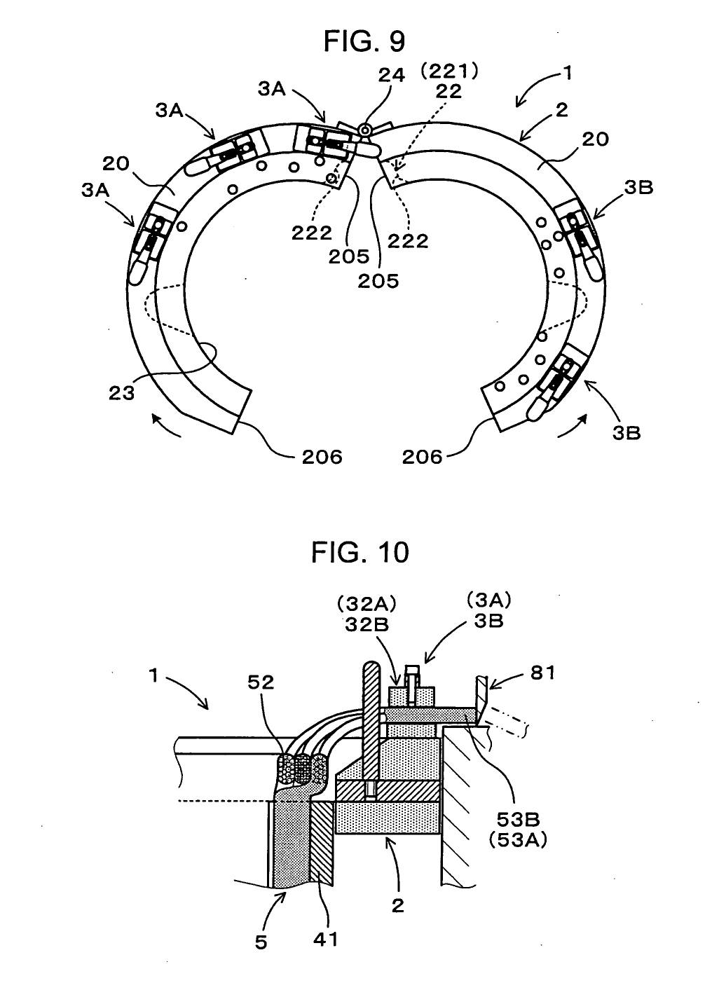

At this time, as shown in FIG. 9, the two plate portions 20 of the base plate 2 of the assembling jig 1 are separated from each other with the connecting portion 24 as a center. As shown in FIG. 1, after passing the coil end portions 52 of the wound coils 5 disposed at the stator core 41 between other ends 206 of the two plate portions 20, the two plate portions 20 are brought together with the connecting portion 24 as a center. By this, as shown in FIG. 2, the base plate 2 is mounted to the end 410 of the stator core 41 in the axial direction so as to surround the coil end portions 52 from a direction orthogonal to the axial direction L of the stator core 41. Thus, the assembling jig 1 can be easily mounted to the stator core 41.

Also, as shown in FIG. 1, the assembling jig 1 is mounted to the stator core 41 while being positioned with respect to the stator core 41 in the circumferential direction C by the positioning means 22 of the base plate 2.

Next, as shown in FIGS. 1 and 2, in the lead wire length determining step, the first lead wires 53A in the two sets of U-phase wound coils 5U are extended to the first holding clamp 32A through the first extension route 311A defined by the two guide pins 312. Then, the first lead wires 53A are each clamped between the secured member 321 and the clamping member 323 of the first holding clamp 32A so as to not move while bundled together. Similarly, the first lead wires 53A at the V-phase wound coils 5V and the first lead wires 53A at the W-phase wound coils 5W are held by the respective first holding clamps 32A.

Also, in the lead wire length determining step, the second lead wires 53B at the three-phase wound coils 5 are extended to the second holding clamps 32B through the second extension routes 311B defined by the respective four guide pins 312. Then, the second lead wires 53B are clamped in a bundled state between the secured members 321 and the clamping members 323 of the second holding clamps 32B so as to not move.

As shown in FIG. 1, in holding the first lead wires 53A and the second lead wires 53B, the assembling jig 1 is mounted to the stator core 41 while being positioned at the stator core 41, so that the position of the assembling jig 1 relative to the stator core 41 in the circumferential direction C is determined. Therefore, the first lead wires 53A and the second lead wires 53B can be held by the first holding means 3A and the second holding means 3B with the lengths thereof being determined to specified lengths.

As shown in FIG. 10, the first lead wires 53A and the bundled second lead wires 53B can be cut to the specified lengths by a cutter 81 which can be positioned at a predetermined distance between the first holding clamps 32A and the second holding clamps 32B.

Therefore, in the lead wire length determining step, due to the use of the assembling jig 1, the first lead wires 53A and the second lead wires 53B do not need to be placed along the coil end portions 52 at the time of determining the length of the first lead wires 53A and the second lead wires 53B. Consequently, it is not necessary to subject the coil end portions 52 to intermediate shaping in determining the lengths of the first lead wires 53A and the second lead wires 53B. As a result, the amount of time required to determine the lengths of the first lead wires 53A and the second lead wires 53B can be reduced.

Also, because the lengths of the first lead wires 53A and the bundled second lead wires 53B are determined by the assembling jig 1, these lengths are not erroneously determined, so that the lengths of the lead wires can be prevented from being different.

Next, in the crimping terminal connecting step, with the first lead wires 53A held by the first holding means 3A, the first crimping terminals 6A are connected by crimping to the ends of the first lead wires 53A, so that the U-phase, V-phase, and W-phase power cables 71 for electrical power supply are formed. With the bundled second lead wires 53B held by the second holding means 3B, the second crimping terminals 6B are connected by crimping to the ends of the bundled second lead wires 53B, so that the neutral points 72 are formed in the three-phase motor.

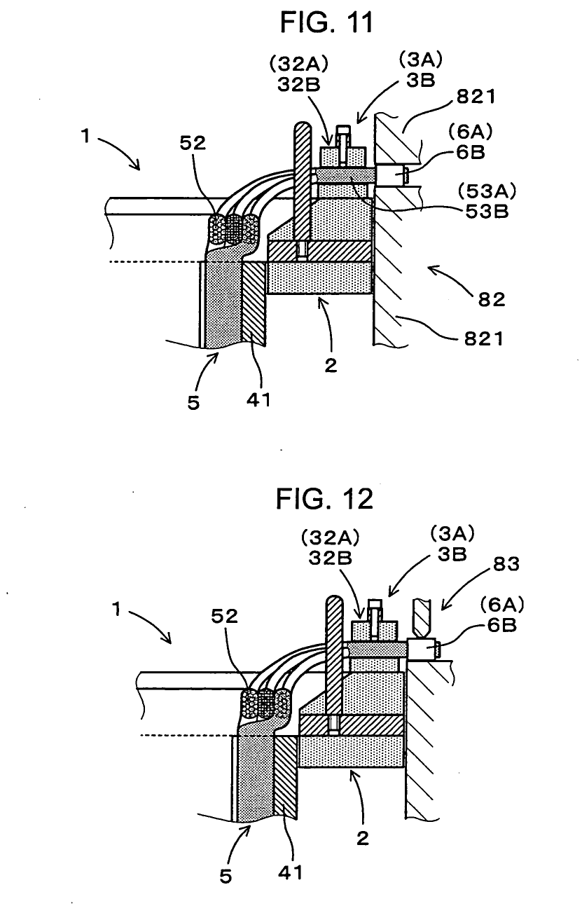

As shown in FIG. 11, in connecting the second crimping terminals 6B by crimping, the bundled second lead wires 53B, which are held by the second holding means 3B, are positioned between a pair of pressing portions 821 of a crimping device 82. The second crimping terminals 6B are inserted onto the ends of the bundled second lead wires 53B in the crimping device 82. The second crimping terminals 6B which have received the ends of the bundled second lead wires 53B are pressed by the pair of pressing portions 821 so as to be crimped, and electrical current is fed between the pair of pressing portions 821 in order to fuse the ends of the bundled second lead wires 53B and the second crimping terminals 6B.

Accordingly, insulating coating covering the surfaces of the multiple electrical wires 500 forming the second lead wires 53B start to be melted by the heat. With the insulating coating removed, the electrical wires 500 are compacted in order to connect the second crimping terminals 6B to the ends of the bundled second lead wires 53B by crimping.

Similarly, the first crimping terminals 6A can also be connected by crimping to the first lead wires 53A by the crimping device 82.

In connecting the crimping terminals 6A, 6B by crimping, the first lead wires 53A and the bundled second lead wires 53B are each held by the respective first holding means 3A and the respective second holding means 3B so as to not move. Accordingly, the electrical wires 500 forming the first lead wires 53A and the second lead wires 53B do not separate from each other, so all of the electrical wires 500 can be connected by crimping to the crimping terminals 6A, 6B more easily.

Next, in the step of shaping the coil end portions, first, the power cables 71 and the neutral points 72 are removed from the first holding means 3A and the second holding means 3B. Then, the two plate portions 20 of the base plate 2 are separated from each other with the connecting portion 24 as the center in order to remove the assembling jig 1 from the stator core 41.

The second crimping terminals 6B forming the neutral points 72 and the second lead wires 53B connected to the second crimping terminals 6B are disposed at the coil end portions 52 in the circumferential direction C of the coil end portions 52 of the wound coils 5. At this time, the second lead wires 53B connected to the second crimping terminals 6B by the assembling jig 1 are of a specified length, so that the neutral points 72 can be disposed at specified positions of the coil end portions 52. The second crimping terminals 6B are pressed and temporarily fixed at the specified positions of the coil end portions 52 so that the second crimping terminals 6B forming the neutral points 72 do not move.

Thereafter, the coil end portions 52 of the wound coils 5 disposed at the stator core 41 are subjected to finishing shaping, so that the shapes of the coil end portions 52 are shaped.

In this way, in the present embodiment, because the lengths of the first lead wires 53A and the second lead wires 53B can be determined by the assembling jig 1, the step of shaping the coil end portions 52 only needs to be carried out once to complete the mounting of the wound coils 5 to the stator core 41.

Also, as described above, with the present embodiment, because the lengths of the first lead wires 53A and the second lead wires 53B are determined by the assembling jig 1, the neutral points 72 in the motor and the power cables 71 can be formed without differences in the lengths within a short time.

Also, the assembling jig 1 is used in the lead wire length determining step and the crimping terminal connecting step. Therefore, the base plate 2 of the assembling jig 1 can protect the coil end portions 52 of the wiring coils 5 disposed at the stator core 41 from, for example, scratching.

Also, the lead wire length determining step can be carried out while the stator core 41, having the wound coils 5 disposed thereat, is placed in a rotating device (not shown). The crimping terminal connecting step can be carried out after moving the lead wires 53 towards an arbitrary position in the circumferential direction C by rotating the rotating device after carrying out the lead wire length determining step.

In this case, after carrying out the lead wire length determining step, the crimping terminal connecting step can be carried out by the crimping device 82 simply by rotating the rotating device. In other words, the crimping device 82 can be fixed with a predetermined positional relationship with the rotating device, so that the first lead wires 53A and the bundled second lead wires 53B at the wound coils 5 can be moved to the crimping device 82 simply by rotating the rotating device. Thus, the crimping terminal connecting step is facilitated.

Also, as described above, the radial-direction external end portions 325 of the holding clamps 32A, 32B are disposed at positions having approximately the same radius from the center O of the base plate 2. Accordingly, at the time of rotating the rotating device so as to cause the holding clamps 32A, 32B to sequentially face the cutting device 81, the same distance can be kept as to the cutting device 81 for the radial-direction external end portions 325 of each of the holding clamps 32A, 32B.

Thus, the length extended externally from the radial-direction external end portions 325 of each of the holding clamps 32A, 32B can be cut to the same length for each of the lead wires 53A, 53B, so that each of the lead wires 53A, 53B can be cut to the specified length. Also, the holding clamps 32A, 32B can be easily made to face the cutting device 81, and cutting of the lead wires 53A, 53B can be easily performed.

Note that the crimping terminal connecting step can be carried out after moving the lead wires 53 towards an arbitrary position in the circumferential direction C by loading the stator core 41, upon which are mounted the wound coils 5, onto the rotating device and rotating the rotating device after carrying out the lead wire length determining step.

As shown in FIG. 12, in the crimping terminal connecting step, the fusing by the crimping device 82 may be carried out after disposing the first crimping terminals 6A or the second crimping terminals 6B to the ends of the first lead wires 53A or the ends of the bundled second lead wires 53B, and pressing to deform and temporarily fixing these by a temporary fixing device 83. In this case, temporarily fixing the first crimping terminals 6A and the second crimping terminals 6B prior to connection by crimping (fusing) by the crimping device 82 enables preventing the first crimping terminals 6A and the second crimping terminals 6B from falling out, or separating when the rotating device is rotated. Thus the amount of time required for the fusing is reduced by the temporary fixing before the fusing.

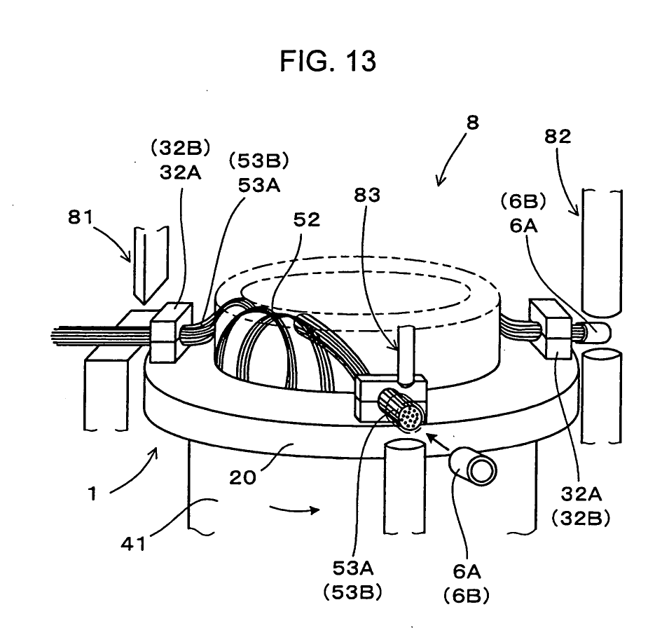

In a second exemplary embodiment, shown in FIG. 13, a wound coil assembling device 8 is configured so as to use the assembling jig 1 illustrated in the first exemplary embodiment to efficiently perform the working processes of the cutting processing, temporary fixing processing, and crimping processing of the lead wires 53A, 53B.

The assembling device 8 comprises lead wire processing means for performing work processing on the lead wires 53A, 53B regarding which the length has been determined by the assembling jig 1, and relative movement means for relative movement between the lead wire processing means and the assembling jig 1.

The assembling device 8 is configured so as to sequentially perform work processing on the lead wires 53A, 53B held by the holding means 3A, 3B, by the lead wire processing means.

The lead wire processing means, according to the present embodiment, comprises a cutting device 81 for cutting the lead wires 53A, 53B in the state of being externally extended in the radial direction R of the holding clamps 32A, 32B, outwards in the radial direction R of the holding clamps, 32A, 32B, a temporary fixing device 83 for temporarily fixing the crimping terminals 6A, 6B on the tips of the lead wires 53A, 53B cut by the cutting device 81, and a crimping device 82 for connecting the crimping terminals 6A, 6B temporarily fixed by the temporary fixing device 83 by crimping.

Note that the structures of the cutting device 81, temporary fixing device 83, and the crimping device 82, are each the same as those in the first exemplary embodiment. Also, the relative movement means are configured of a rotating device (not shown) to which the assembling jig 1 is loaded and held, and rotated.

Also, FIG. 13 is a diagram illustrating the assembly device 8, with the detailed configuration substantially the same as that found in the first exemplary embodiment except for the temporary fixing device 83.

With the present embodiment as well, up to determining of the length of the first lead wires 53A and the second lead wires 53B with the assembling jig 1 is the same as with the first embodiment.

Following cutting a lead wire 53A or 53B held by one of the holding clamps 32A, 32B with the cutting device 81 to the specified length, the rotating device is rotated so that the next holding clamp 32A or 32B faces the cutting device 81, and the lead wire 53A or 53B held thereby is cut to the specified length. Subsequently, the rotating device is further rotated so that the next holding clamp 32A or 32B faces the cutting device 81, and the lead wire 53A or 53B held by the holding clamp 32A or 32B is cut to the specified length. Thus, the lead wires 53A, 53B can be easily cut.

Next, a crimping terminal 6A or 6B is attached to the tip of a lead wire 53A or 53B held by one of the holding clamps 32A, 32B. Following temporarily fixing the crimping terminal 6A or 6B with the temporary fixing device 83, the rotating device is rotated so that the next holding clamp 32A or 32B faces the temporary fixing device 83, and a crimping terminal 6A or 6B is temporarily fixed to the tip of the lead wire 53A or 53B held thereby. Subsequently, the rotating device is further rotated so that the next holding clamp 32A or 32B faces the temporary fixing device 83, and crimping terminal 6A or 6B is temporarily fixed to the tip of the lead wire 53A or 53B held by the holding clamp 32A or 32B. Thus, temporary fixing of the crimping terminals 6A, 6B can be easily performed.

Next, following connecting by crimping a crimping terminal 6A or 6B, attached to the tip of a lead wire 53A or 53B held by one of the holding clamps 32A, 32B with the crimping device 82, the rotating device is rotated so that the next holding clamp 32A or 32B faces the crimping device 82, and the crimping terminal 6A or 6B attached to the tip of the lead wire 53A or 53B is connected by crimping. Subsequently, the rotating device is further rotated so that the next holding clamp 32A or 32B faces the crimping device 82, and crimping terminal 6A or 6B attached to the tip of the lead wire 53A or 53B held by the holding clamp 32A or 32B is connected by crimping. Thus, connection by crimping of the crimping terminals 6A, 6B can be easily performed.

Note that an arrangement may be made wherein the cutting, temporary fixing, and crimping is performed on a lead wire 53A or 53B held by one of the holding clamps 32A, 32B, following which the cutting, temporary fixing, and crimping is performed on a lead wire 53A or 53B held by the next holding clamp 32A or 32B, and thus the working processing is sequentially performed with regard to the lead wires 53A, 53B held by the holding clamps 32A, 32B.

Also, while temporarily fixing or crimping of one of the lead wires 53A or 53B is being performed, cutting of another lead wire 53A or 53B may be performed. Also, while crimping of one of the lead wires 53A or 53B is being performed, cutting or temporary fixing of another lead wire 53A or 53B may be performed.

According to the assembling device 8 of the present embodiment, work processing of multiple lead wires 53A, 53B can be easily performed while preventing the differences in the lengths using the assembling jig 1.

With the present embodiment as well, the rest is the same as with the first exemplary embodiment, and the same operational advantages as with the first exemplary embodiment can be obtained.

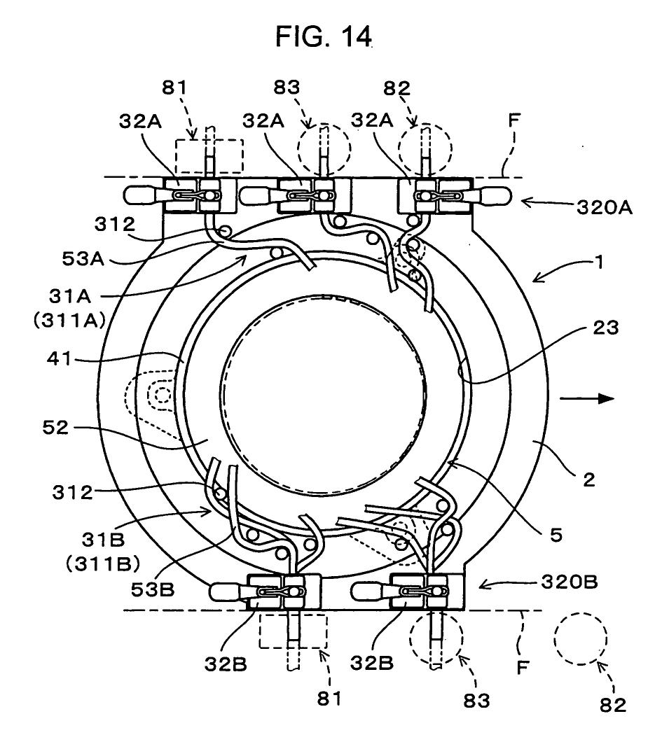

As shown in FIG. 14, the third exemplary embodiment is an example wherein the holding clamps 32A, 32B are disposed on the base plate 2 so as to be arrayed on two mutually parallel virtual straight lines F on either side of the center O of the base plate 2.

That is to say, with the present embodiment, each of the first holding clamps 32A and each of the second holding clamps 32B are arrayed on mutually parallel separate virtual straight lines F. Also, the first holding clamps 32A and the second holding clamps 32B form linearly-arrayed clamp rows 320A, 320B, respectively.

Also, the assembling device 8 according to the present embodiment has a slide device (omitted from the drawing) for linearly sliding the assembling jig 1, and comprises cutting devices 81, temporary fixing devices 83, and crimping devices 82, at positions facing the first linearly-arrayed clamp row 320A of the first holding clamps 32A and the second linearly-arrayed clamp row 320B of the second holding clamps 32B.

The slide device is slid which enables the first holding clamps 32A and the second holding clamps 32B to each sequentially face the cutting devices 81, temporary fixing devices 83, and crimping devices 82, so that the lead wires 53A, 53B held by the holding clamps 32A, 32B can be sequentially subjected to the working processing of cutting, temporary fixing, and crimping.

Note that an arrangement may be made for the assembling device 8 wherein only one set of the cutting device 81, temporary fixing device 83, and crimping device 82 is provided, and the assembling jig 1 is rotated by a rotating device as well as being slidable by a sliding device. In this case, the sliding device is slid so that the lead wires 53A (53B) in the one linearly-arrayed clamp row 320A (320B) are subjected to the work processing of cutting, temporary fixing, and crimping, following which the rotating device is rotated, and the other linearly-arrayed clamp row 320B (320A) is made to face the cutting device 81, temporary fixing device 83, and crimping device 82. The sliding device is then slid so that the lead wires 53B (53A) in the one linearly-arrayed clamp row 320B (320A) can be subjected to the working processing of cutting, temporary fixing, and crimping.

With the present embodiment as well, while temporary fixing or crimping of one of the lead wires 53A or 53B is being performed, cutting of another lead wire 53A or 53B may be performed. Also, while crimping of one of the lead wires 53A or 53B is being performed, cutting or temporary fixing of another lead wire 53A or 53B may be performed.

With the present embodiment as well, the remaining actions and structure are the same as with the first and second exemplary embodiments, and the same operational advantages as with the first and second exemplary embodiments can be obtained.

1. A wound coil assembling jig for determining the length of a lead wire disposed at an end of the wound coil assembled onto a stator core, the assembling jig comprising:
a base plate having a mounting face mounted to an end of the stator core in an axial direction of the stator core, positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction; and
holding means, disposed at an outer face of the base plate opposite to the mounting face, for holding the lead wire.

2. The wound coil assembling jig according to claim 1, wherein the holding means comprises an extension guide contacting the lead wire and defining an extension route for the lead wire, and a clamp holding the lead wire extending in the extension route.

3. The wound coil assembling jig according to claim 1, wherein the wound coil is a three-phase wound coil, and the lead wire for each phase is formed of a first lead wire formed at one end of the wound coil corresponding to the phase, and a second lead wire formed at the other end of the wound coil corresponding to the phase;
and wherein the holding means comprise first holding means separately holding each first lead wire, and second holding means bundling and holding the second lead wires.

4. The wound coil assembling jig according to claim 1, wherein the base plate is dividable into a plurality of plate portions in the circumferential direction of the insertion opening.

5. The wound coil assembling jig according to claim 4, wherein the base plate has two plate portions, with the ends of the two plate portions connected together at an end thereof, and the two plate portions being capable of being opened and closed with the connecting portion as a center.

6. The wound coil assembling jig according to claim 2, wherein a plurality of the holding means are disposed on the base plate, with the holding clamps configured so as to hold the lead wires extended outwards in the radial direction of the base plate.

7. The wound coil assembling jig according to claim 6, wherein each holding clamp is disposed on an imaginary circle.

8. The wound coil assembling jig according to claim 6, wherein each holding clamp is disposed on one or a plurality of imaginary straight lines.

9. A wound coil assembling method for assembling a wound coil to a stator core, the method comprising:
a step for disposing the wound coil, in which a portion of the wound coil is inserted into a slot formed in the inner circumferential surface of the stator core and the remaining portion of the wound coil is protruded from an end of the stator core in an axial direction of the stator core to form a coil end portion;
a lead wire length determining step, in which a mounting face of an assembling jig is mounted to the end of the stator core in the axial direction of the stator core and the assembling jig and the stator core are positioned in a circumferential direction of the stator core by positioning means, in which state the lead wire disposed at an end of the wound coil is held by holding means, and the held lead wire is cut, using an assembling jig with a base plate having a mounting face mounted to an end of the stator core in an axial direction of the stator core, positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction, and holding means, disposed at an outer face of the base plate opposite to the mounting face, for holding the lead wire;
a crimping terminal connecting step for connecting a crimping terminal to the tip of the lead wire by crimping, with the lead wire held by the assembling jig; and
a coil end shaping step for shaping the coil end portion.

10. The wound coil assembling method according to claim 9, wherein the wound coil is a three-phase wound coil, and the lead wire for each phase is formed of a first lead wire formed at one end of the wound coil corresponding to the phase, and a second lead wire formed at the other end of the wound coil corresponding to the phase;
wherein, in the lead wire length determining step, each first lead wire is separately held and cut, and the second lead wires are held and cut in a bundled state;
and wherein, in the crimping terminal connecting step, a first crimping terminal is connected by crimping to the ends of the first lead wires, so that a power cable for power supply is formed, and a second crimping terminal is connected by crimping to an end of the second lead wires held in the bundled state, so that a neutral point is formed.

11. The wound coil assembling method according to claim 9, wherein a plurality of the holding means are disposed on the base plate, the holding means comprising an extension guide contacting the lead wire and defining an extension route for the lead wire, and a clamp holding the lead wire extending in the extension route;
and wherein in the lead wire length determining step, the holding clamps hold the lead wires in a state extended outwards in the radial direction of the base plate, and the held lead wires are cut.

12. The wound coil assembling method according to claim 11, wherein each holding clamp is disposed on an imaginary circle.

13. The wound coil assembling jig according to claim 11, wherein each holding clamp is disposed on one or a plurality of imaginary straight lines.

14. The wound coil assembling method according to claim 9, wherein the lead wire length determining step is carried out while the stator core is loaded on a rotating device, and the crimping terminal connecting step is carried out after moving the lead wire or lead wires to an arbitrary location in the circumferential direction of the stator core by rotating the rotating device following the lead wire length determining step.

15. The wound coil assembling method according to claim 9, wherein the crimping terminal connecting step is carried out after moving the lead wire or lead wires to an arbitrary location in the circumferential direction of the stator core by loading the stator core on which the wound coils are mounted onto the rotating device, and rotating the rotating device following the lead wire length determining step.

16. A wound coil assembling device, comprising:
a wound coil assembling jig for determining the length of a lead wire disposed at an end of the wound coil assembled onto a stator core;
lead wire processing means for performing work processing of the lead wire of which the length has been determined by the assembling jig; and
relative movement means for relative movement between the lead wire processing means and the assembling jig, the assembling jig comprising:
a base plate having a mounting face mounted to an end of the stator core in an axial direction of the stator core, positioning means disposed at the mounting face and positioning the jig with respect to the stator core in a circumferential direction of the stator core, and an insertion opening into which can be inserted a coil end portion which is a portion of the wound coil protruding from the end of the stator core in the axial direction, and
holding means, disposed at an outer face of the base plate opposite to the mounting face, for holding the lead wire of the wound coil, wherein a plurality of the holding means are disposed on the base plate, and, following determining the length of the lead wire with the assembling jig, the lead wire processing means and the assembling jig are relatively moved by the relative movement means, whereby each lead wire held by each holding means is sequentially moved to the lead wire processing means, where the lead wire work processing is sequentially performed by the lead wire processing means.

17. The wound coil assembling device according to claim 16, the holding means comprising an extension guide contacting the lead wire and defining an extension route for the lead wire, and a clamp holding the lead wire extending in the extension route;
wherein the holding clamps hold the lead wires in a state extended outwards in the radial direction of the base plate.

18. The wound coil assembling device according to claim 17, wherein each holding clamp is disposed on an imaginary circle, and wherein the relative movement means is a rotating device for relatively rotating the lead wire processing means and the assembling jig.

19. The wound coil assembling device according to claim 17, wherein each holding clamp is disposed on one or a plurality of imaginary straight lines, and wherein the relative movement means is a sliding device for relatively linearly moving the lead wire processing means and the assembling jig.

20. The wound coil assembling device according to claim 16, wherein the work processing performed by the lead wire processing means is at least one of cutting processing of the lead wire regarding which the length has been determined by the assembling jig, and crimping processing for performing connection by crimping of crimping terminals to the tips of lead wires following the cutting processing.
